(19) United States
(12) Patent Application Publication
(10) Pub. No.: US 2018/0105621 A1
(43) Pub. Date: Apr. 19, 2018

(54) A PROCESS FOR CONTROLLING PARTICLE SIZE DISTRIBUTION OF A ZIEGLER-NATTA CATALYST COMPOSITION

(71) Applicant: RELIANCE INDUSTRIES LIMITED, Mumbai, Maharashtra (IN)

(72) Inventors: Virendrakumar GUPTA, Mumbai, Maharashtra (IN); Bhavesh Kiritbhai DESAI, Surat Gujarat (IN); Ajay Vinodlal KOTHARI, Surat, Gujarat (IN)

(73) Assignee: RELIANCE INDUSTRIES LIMITED, Mumbai, Maharashtra (IN)

(21) Appl. No.: 15/564,750

(22) PCT Filed: Apr. 7, 2016
(86) PCT No.: PCT/IB2016/051966

§ 371 Date: Oct. 6, 2017

(30) Foreign Application Priority Data
Apr. 7, 2015 (IN) 1457/MUM/2015

(51) Int. Cl. C08F 110/02

(52) U.S. Cl. CPC C08F 110/02; C08F 2500/24

(57) ABSTRACT

The present disclosure relates to a process for controlling particle size distribution of a Ziegler-Natta catalyst composition. In order to control the particle size distribution, magnesium metal is reacted with a mixture comprising a first alcohol and a second alcohol to obtain a slurry which includes a mixture of magnesium alkoxides and unreacted alcohol. The unreacted alcohol is separated from the slurry to obtain the mixture of magnesium alkoxides having reduced methoxy content less than 2 wt %. The mixture of magnesium alkoxides is chlorinated to obtain a Ziegler-Natta pro-catalyst. The Ziegler-Natta pro-catalyst is mixed with a co-catalyst to obtain a Ziegler-Natta catalyst composition with controlled particle size distribution in the range of 5 μm to 15 μm.

### FIELD

The present disclosure relates to Ziegler-Natta catalyst compositions.

### BACKGROUND

Ultra High Molecular Weight Polyethylene (UHMWPE) is a polyethylene having high density and a molecular weight in the range of 3 million to 6 million. UHMWPE is used for a wide range of applications. However, a polyethylene with high density and molecular weight does not have ability to melt or flow as a molten liquid. Therefore, for industrial applications, UHMWPE needs to be in powder form with narrow particle size distribution (PSD). This is because, UHMWPE powder with narrow particle size distribution can be molded into different shapes using different processing methods such as injection molding, blow molding, and the like. Therefore, the particle size distribution of UHMWPE powder is a crucial parameter.

Olefin gas, particularly ethylene gas, is polymerized in a reactor, at a desired temperature and at a desired pressure, and in the presence of a catalyst composition, to produce UHMWPE in powder form having a desired particle size distribution.

Generally, a Ziegler-Natta catalyst composition is used as a catalyst in olefin polymerization. The Ziegler-Natta catalyst composition comprises a Ziegler-Natta pro-catalyst, a co-catalyst, and at least one electron donor. A magnesium alkoxide is used as a precursor for preparing the Ziegler-Natta pro-catalyst. Conventionally, the Ziegler-Natta pro-catalyst is prepared using pure magnesium ethoxide having a non-uniform particle size distribution. The Ziegler-Natta pro-catalyst is further mixed with a co-catalyst, and at least one electron donor in a desired proportion to obtain the Ziegler-Natta catalyst composition having a non-uniform particle size distribution, thereby producing a non-uniform particle size UHMWPE.

However, there are certain limitations associated with the non-uniform particle size of the Ziegler-Natta catalyst, for example:
decreased throughput;
inability to flow; and
choking of process equipment.

Therefore, there is felt a need for an alternative process to prepare a Ziegler-Natta catalyst composition that obviates the above-mentioned drawbacks.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a process to prepare a Ziegler-Natta catalyst composition.

Other objects and advantages of the present disclosure will be more apparent from the following description, which is not intended to limit the scope of the present disclosure.

### SUMMARY

The present disclosure envisages a process for controlling particle size distribution of a Ziegler-Natta catalyst composition. The process is carried out by reacting magnesium metal with a mixture comprising a first alcohol and a second alcohol, in a pre-determined molar ratio ranging from 30:1 to 50:1, at a temperature in the range of 40° C. to 120° C., and in the presence of iodine, to obtain a slurry comprising a mixture of magnesium alkoxides and unreacted alcohol. In order to obtain the mixture of magnesium alkoxides with a reduced methoxy content less than 2 wt %, the unreacted alcohol is separated from the slurry. The mixture of magnesium alkoxides is chlorinated in a hydrocarbon medium, using a chlorinating agent, to obtain a Ziegler-Natta pro-catalyst. The Ziegler-Natta pro-catalyst is then mixed with a co-catalyst, in a pre-determined molar ratio ranging from 1:2 to 1:1, while stirring at a pre-determined rate in the range of 1000 rpm to 1500 rpm, to obtain the Ziegler-Natta catalyst composition with controlled particle size distribution in the range of 5 μm to 15 μm

The ratio of the magnesium metal and the iodine can be in the range of 10:1 to 100:1

The co-catalyst can be at least one selected from the group consisting of triethylaluminium, tridecylaluminium, tri-n-butylaluminium, tri-isopropylaluminium, tri-isoprenylaluminium, tri-isobutylaluminium, ethylaluminium sesquichloride, diethylaluminium chloride, di-isobutylaluminium chloride, triphenylaluminium, tri-n-octyl aluminium, and tri-n-decylaluminium.

The hydrocarbon medium can be at least one selected from the group consisting of hexane, decane, heptane, chlorobenzene, toluene, and cyclohexane.

The chlorinating agent can be at least one of titanium tetrachloride and chlorobenzene.

The methoxy content in the mixture of magnesium alkoxides can be reduced in the range of 0.1 wt % to 2 wt %.

The first alcohol can be methanol and the second alcohol can be one of ethanol, propanol and butanol.

Polyethylene having a particle size distribution in the range of 180 μm to 320 μm can be obtained by subjecting ethylene to polymerization in the presence of the Ziegler-Natta catalyst composition.

### DETAILED DESCRIPTION

A Ziegler-Natta pro-catalyst is conventionally prepared using pure magnesium ethoxide having a non-uniform particle size distribution. Due to this, the Ziegler-Natta pro-catalyst when mixed with a co-catalyst, and at least one electron donor in a desired proportion, a Ziegler-Natta catalyst composition with a non-uniform particle size distribution is prepared.

However, following are the limitations associated with the use of the non-uniform particle size Ziegler-Natta catalyst composition for polymerization:
the particle size of the resultant product (UHMWPE) is non-uniform;
throughput is decreased;
flow is ineffective; and
process equipment are choked.

The present disclosure, therefore, envisages a process for controlling particle size distribution of a Ziegler-Natta catalyst composition so as to overcome the above mentioned drawbacks.

The process is carried out in multiple steps, which are described herein below.

In the first step, magnesium metal is reacted with a mixture comprising a first alcohol and a second alcohol, in a pre-determined molar ratio ranging from 30:1 to 40:1, at a temperature in the range of 40° C. to 120° C., and in the presence of iodine, to obtain a slurry. The slurry includes a mixture of magnesium alkoxides and unreacted alcohol.

The first alcohol can be methanol, and the second alcohol can be one of ethanol, propanol, and butanol.

The ratio of magnesium metal and iodine can be in the range of 10:1 to 100:1.

Iodine is an initiator, i.e., it facilitates in initiating the reaction of magnesium metal with the mixture comprising the first alcohol and the second alcohol.

As described herein above, the particle size distribution of a Ziegler-Natta catalyst composition depends upon the particle size distribution of a Ziegler-Natta pro-catalyst. In order to obtain the Ziegler-Natta pro-catalyst of a desired particle size distribution, it is necessary to maintain or reduce the methoxy content in the mixture of magnesium alkoxides to less than 2 wt %. The methoxy content can be reduced by reducing the content of alcohol. Therefore, in the second step, the unreacted alcohol is separated from the slurry to obtain the mixture of magnesium alkoxides with a reduced methoxy content of less than 2 wt %. In accordance with one embodiment of the present disclosure, the methoxy content in the mixture of magnesium alkoxides can be in the range of 0.1 wt % to 2 wt %.

The separated alcohol can be reused in the first step to obtain the slurry.

In the third step, the mixture of magnesium alkoxides is chlorinated in a hydrocarbon medium, using a chlorinating agent, to obtain the Ziegler-Natta pro-catalyst having a desired particle size distribution, specifically narrow particle size distribution.

The hydrocarbon medium can be at least one selected from the group consisting of hexane, decane, heptane, chlorobenzene, toluene, and cyclohexane.

The chlorinating agent is at least one of titanium tetrachloride and chlorobenzene.

In the fourth step, the Ziegler-Natta pro-catalyst is mixed with a co-catalyst, in a pre-determined ratio ranging from 1:2 to 1:1, while stirring at a pre-determined rate in the range of 1000 rpm to 1500 rpm, to obtain the Ziegler-Natta catalyst composition with controlled particle size distribution in the range of 5 μm to 15 μm. The co-catalyst can be at least one selected from the group consisting of triethylaluminium, tridecylaluminium, tri-n-butylaluminium, tri-isopropylaluminium, tri-isoprenylaluminium, tri-isobutylaluminium, ethylaluminium sesquichloride, diethylaluminium chloride, di-isobutylaluminium chloride, triphenylaluminium, tri-n-octyl aluminium, and tri-n-decylaluminium.

In the Ziegler-Natta pro-catalyst, the pre-determined proportion between magnesium (Mg), titanium (Ti), and chlorine (Cl) can be 1:1.2:4.6.

In accordance with one embodiment of the present disclosure, the particle size distribution of the Ziegler-Natta catalyst composition can be controlled by varying the concentration of the initiator. Particularly, the mean particle size distribution of the Ziegler-Natta catalyst composition increases with increase in the concentration of the initiator.

Moreover, the particle size distribution of the Ziegler-Natta catalyst composition can be controlled by controlling the particle size of the Ziegler-Natta catalyst composition. The process of the present disclosure also aids in controlling the particle size of the Ziegler-Natta catalyst composition in a desired range.

In accordance with the present disclosure, olefin, particularly ethylene, is subjected to polymerization in the presence of the Ziegler-Natta catalyst composition having controlled particle size distribution in the range of 5 μm to 15 μm, to obtain polyethylene (UHMWPE) having controlled particle size distribution in the range of 180 μm to 320 μm and a better flow ability. Specifically, the particle size distribution of the resultant product (UHMWPE) is controlled by the particle size distribution of the Ziegler-Natta catalyst composition.

The resultant product prepared using the Ziegler-Natta catalyst composition of the present disclosure has very low melt flow index (MFI). Particularly, melt flow index is inversely proportional to molecular weight. Therefore, the resultant product prepared using the Ziegler-Natta catalyst composition of the present disclosure has a higher molecular weight.

The present disclosure is further described in light of the following experiments which are set forth for illustration purpose only and not to be construed for limiting the scope of the disclosure. The following laboratory scale experiments can be scaled up to industrial/commercial scale.

Experiment 1a: Preparation of the Mixture of Magnesium Alkoxides

A reactor was charged with 250 ml of a mixture comprising methanol and ethanol. 10 g of magnesium metal was added to the reactor under nitrogen atmosphere followed by stirring at 300 rpm using a magnetic stirrer. After stirring for 20 minutes, 0.3 g of iodine (initiator) was added to the reactor. This was immediately accompanied by the evolution of hydrogen gas indicating the initiation of the reaction. The hydrogen gas evolution was monitored visually and the temperature was increased in a stepwise manner from 40° C. to 80° C. After the evolution of hydrogen gas ceased, the mixture of alcohols was evaporated at higher temperature to obtain a slurry comprising a mixture of alkoxides, i.e., magnesium ethoxide and magnesium methoxide.

Magnesium content of the mixture of magnesium alkoxides was determined by a volumetric method, composition of the magnesium alkoxides (ethoxy/methoxy content) was determined by gas chromatography, and a particle size distribution of the mixture of magnesium alkoxides was determined using a particle size analyzer (CILAS-1190D). The results are tabulated in Table-1.

TABLE 1

| | | | | | | | | Precursor |
|---|---|---|---|---|---|---|---|---|
| | | | | | | | Mean | Bulk |
| | | | | | | | PSD- | Density |
| Magnesium | Mg | Ethoxy | Methoxy | | | | magnesium | (gm/ml) |
| alkoxide | (wt %) | (wt %) | (wt %) | D10 | D50 | D90 | alkoxides | Tapped |
| Precursor | 21.3 | 69.6 | 6.9 | 18 | 27 | 41 | 28 | 0.56 |
| 01 | | | | | | | | |
| Precursor | 21.8 | 70.5 | 3.9 | 17 | 34 | 50 | 34 | 0.45 |
| 02 | | | | | | | | |
| Precursor | 20.7 | 73.8 | 1.9 | 16 | 27 | 41 | 27 | 0.41 |
| 03 | | | | | | | | |
| Precursor | 21.1 | 77 | 0 | 14 | 26 | 44 | 27 | 0.32 |
| 04 | | | | | | | | |

Inference:

From Table-1, it can be inferred that, with reduction in the methoxy content, mean PSD of magnesium alkoxides is not affected. However, with reduction in the methoxy content, the bulk density of magnesium alkoxides is reduced.

Experiment 1b: Preparation of the Ziegler-Natta Pro-Catalyst

A reactor was charged with hexane and the mixture of alkoxides obtained in Experiment 1a was added to the reactor under nitrogen atmosphere. 0.88 ml of titanium tetrachloride (TiCl₄) was added to the mixture for 5.5 hours at 85° C. The reaction temperature was increased to 120° C., and the temperature of 120° C. was maintained for 60 hours to obtain a Ziegler-Natta pro-catalyst followed by washing with hexane at 70° C. In the Ziegler-Natta pro-catalyst, the pre-determined proportion between magnesium (Mg), titanium (Ti), and chlorine (Cl) was 1:1.2:4.6.

Experiment 2: Effect of the Initiator (Iodine) on the Particle Size Distribution of the Ziegler-Natta Pro-Catalyst.

To study the effect of the initiator on the particle size distribution of the Ziegler-Natta pro-catalyst, the experimental procedure described in Experiment 1a and Experiment 1b was followed by varying the initiator concentration. The results obtained by varying the initiator concentration are tabulated in Table-2.

TABLE 2

| | | | | | | | Mean |
|---|---|---|---|---|---|---|---|
| | | | | | | | PSD- |
| | | | | | | | Zeigler- |
| | | | | | | | Natta |
| Magnesium | Iodine | Mg | Ethoxy | | | | pro- |
| alkoxide | (mg) | (wt %) | (wt %) | D10 | D50 | D90 | catalyst |
| Precursor | 300 | 21.0 | 77.3 | 14 | 26 | 41 | 26 |
| 05 | | | | | | | |
| Precursor | 600 | 21.1 | 77 | 16 | 27 | 54 | 31 |
| 06 | | | | | | | |
| Precursor | 700 | 21.7 | 76.5 | 21 | 35 | 52 | 35 |
| 07 | | | | | | | |
| Precursor | 700 | 21.1 | 77.1 | 25 | 37 | 53 | 37 |
| 08 | | | | | | | |

Inference:

From Table-2, it can be inferred that, with increase in the concentration of iodine, mean PSD of Ziegler-Natta pro-catalyst is increased.

Experiment 3: Preparation of the Ziegler-Natta Catalyst Composition

The Ziegler-Natta pro-catalyst prepared in Experiment 1b was mixed with a co-catalyst, i.e., triethylaluminium (TEAL) in a molar ratio of 0.85 to obtain the Ziegler-Natta catalyst composition.

Experiment 4: Effect of Methoxy Content in the Mixture of Magnesium Alkoxides on the Particle Size Distribution of the Ziegler-Natta Pro-Catalyst and the Ziegler-Natta Catalyst Composition

The experimental procedure described in Experiment 1a was carried out by changing the concentration of methanol and ethanol, to obtain the mixture of magnesium alkoxides with varying methoxy content. The effect of varying methoxy content on the particle size distribution of the magnesium alkoxide, Ziegler-Natta pro-catalyst and the Ziegler-Natta catalyst composition is tabulated in Table-3.

TABLE 3

| | | | PSD (μm) | | | | PSD (μm) | | | |
|---|---|---|---|---|---|---|---|---|---|---|
| | | | magnesium | | | | Zeigler-Natta | | | |
| | | | alkoxide | | | | catalyst composition | | | |
| Mg | Ethoxy | Methoxy | D | D | D | D | D | D | D | D |
| (wt %) | (wt %) | (wt %) | 10 | 50 | 90 | mean | 10 | 50 | 90 | mean |
| 21.3 | 69.6 | 6.9 | 18 | 27 | 41 | 28 | 9 | 26 | 34 | 25 |
| 21.8 | 70.5 | 3.9 | 17 | 34 | 50 | 34 | 4 | 25 | 36 | 23 |
| 20.7 | 73.8 | 1.9 | 16 | 27 | 41 | 27 | 2 | 6 | 22 | 9 |
| 21.1 | 77 | 0 | 14 | 26 | 44 | 27 | 2 | 9 | 19 | 10 |

Inference:

From Table-3, it can be inferred that, with reduction in the methoxy content, PSD of magnesium alkoxide and Ziegler-Natta catalyst composition is reduced.

Experiment 5: Polymerization Using the Ziegler-Natta Catalyst Composition

The Ziegler-Natta catalyst composition prepared in Experiment 3 was taken in a reactor. Hydrogen gas was charged in the reactor. Ethylene gas was introduced into the reactor till the pressure of 6 kg/cm² was attained. Ethylene was polymerized in the reactor at 80° C. under continuous agitation at 400 rpm for 2 hours.

The effect of the particle size distribution of the Ziegler-Natta catalyst composition on productivity (i.e., to produce polyethylene, MFI of the polyethylene (PE), and the particle size distribution of the PE is tabulated in Table-4.

TABLE 4

| Mean PSD | | MFI of | | | | |
|---|---|---|---|---|---|---|
| of Zeigler- | | PE | | | | |
| Natta | | at 2.16 | | | | |
| catalyst | | kg wt | PSD of PE (μm) | | | |
| composition | Productivity | (g/10 | D | D | D | Average |
| (μm) | (kgPE/g cat) | min) | 10 | 50 | 90 | PSD |
| 25 | 2.3 | 0.2 | 175 | 374 | 487 | 364 |
| 23 | 3.5 | 0.2 | 110 | 350 | 480 | 328 |
| 9 | 5.0 | 0.2 | 84 | 276 | 454 | 271 |
| 10 | 4.9 | 0.2 | 69 | 167 | 370 | 191 |

Inference:

From Table-4, it can be inferred that, with reduction in mean PSD of Ziegler-Natta catalyst composition, average PSD of polyethylene is reduced. Specifically, by controlling the PSD of the Ziegler-Natta catalyst composition, the PSD of polyethylene is controlled.

Technical Advances and Economical Significance

The present disclosure described herein above has several technical advantages including, but not limited to, the realization of a process that:
controls the particle size distribution of the Ziegler-Natta catalyst composition in the range of 5 μm to 15 μm, thereby controlling the particle size distribution of the polyethylene in the range of 180 μm to 320 μm.

The disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description.

Descriptions of well-known components and processing techniques are omitted so as to not unnecessarily obscure the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A process for controlling particle size distribution of a Ziegler-Natta catalyst composition; said process comprising the following steps:
a. reacting magnesium metal with a mixture comprising a first alcohol and a second alcohol, in a pre-determined molar ratio ranging from 30:1 to 50:1, at a temperature in the range of 40° C. to 120° C., and in the presence of iodine, to obtain a slurry comprising a mixture of magnesium alkoxides and unreacted alcohol, wherein said first alcohol is methanol and said second alcohol is one of ethanol, propanol and butanol;
b. separating said unreacted alcohol from said slurry to obtain said mixture of magnesium alkoxides having reduced methoxy content less than 2 wt %;
c. chlorinating said mixture of magnesium alkoxides in a hydrocarbon medium, using a chlorinating agent, to obtain a Ziegler-Natta pro-catalyst; and
d. mixing said Ziegler-Natta pro-catalyst with a co-catalyst, in a pre-determined molar ratio ranging from 1:2 to 1:1, while stirring at a pre-determined rate in the range of 1000 rpm to 1500 rpm, thereby obtaining a Ziegler-Natta catalyst composition with controlled particle size distribution in the range of 5 μm to 15 μm.

2. The process as claimed in claim 1, wherein the ratio of the magnesium metal and the iodine is in the range of 10:1 to 100:1.

3. The process as claimed in claim 1, wherein said co-catalyst is at least one selected from the group consisting of triethylaluminium, tridecylaluminium, tri-n-butylaluminium, tri-isopropylaluminium, tri-isoprenylaluminium, tri-isobutylaluminium, ethylaluminium sesquichloride, diethylaluminium chloride, di-isobutylaluminium chloride, triphenylaluminium, tri-n-octyl aluminium, and tri-n-decylaluminium.

4. The process as claimed in claim 1, wherein said hydrocarbon medium is at least one selected from the group consisting of hexane, decane, heptane, chlorobenzene, toluene, and cyclohexane.

5. The process as claimed in claim 1, wherein said chlorinating agent is at least one of titanium tetrachloride and chlorobenzene.

6. The process as claimed in claim 1, wherein the methoxy content in said mixture of magnesium alkoxides is in the range of 0.1 wt % to 2 wt %.

7. Polyethylene having particle size distribution in the range of 180 μm to 320 μm is obtained by subjecting ethylene to polymerization in the presence of a Ziegler-Natta catalyst composition as claimed in claim 1.

8. Polyethylene having particle size distribution in the range of 180 μm to 320 μm is obtained by subjecting ethylene to polymerization in the presence of a Ziegler-Natta catalyst composition as claimed in claim 2.

9. Polyethylene having particle size distribution in the range of 180 μm to 320 μm is obtained by subjecting ethylene to polymerization in the presence of a Ziegler-Natta catalyst composition as claimed in claim 3.

10. Polyethylene having particle size distribution in the range of 180 μm to 320 μm is obtained by subjecting ethylene to polymerization in the presence of a Ziegler-Natta catalyst composition as claimed in claim 4.

11. Polyethylene having particle size distribution in the range of 180 μm to 320 μm is obtained by subjecting ethylene to polymerization in the presence of a Ziegler-Natta catalyst composition as claimed in claim 5.

12. Polyethylene having particle size distribution in the range of 180 μm to 320 μm is obtained by subjecting ethylene to polymerization in the presence of a Ziegler-Natta catalyst composition as claimed in claim 6.
